(19) United States
(12) Patent Application Publication
(10) Pub. No.: US 2007/0050293 A1
(43) Pub. Date: Mar. 1, 2007

(54) Method and apparatus for distributing content to a client device

(76) Inventors: Petr Peterka, San Diego, CA (US); Paul Moroney, Olivenhain, CA (US); Jiang Zhang, LaJolla, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/213,480

(22) Filed: Aug. 26, 2005

(51) Int. Cl. G06Q 99/00

(52) U.S. Cl. 705/50

(57) ABSTRACT

Method, apparatus, and computer readable medium for distributing content to a client device is described. One aspect of the invention relates to distributing pre-encrypted content. In one example, pre-encrypted content is received at a server. Pre-encryption key data associated with the pre-encrypted content is obtained. The pre-encrypted content is decrypted using the pre-encryption key data to produce portions of clear content. The portions of clear content are then re-encrypted as each portion is produced in accordance with unique key data to produce re-encrypted content. The re-encrypted content is distributed from the server towards a client device.

### BACKGROUND OF THE INVENTION

1. Field of the Invention

The present invention relates to content delivery systems and, more particularly, to a method and apparatus for distributing content to a client device.

2. Description of the Background Art

Digital content has gained wide acceptance in the public. Such content includes, but is not limited to: movies, videos, music, and the like. Consequently, many consumers and businesses employ various digital media devices or systems that enable the reception of such digital multimedia content via several different communication channels (e.g., a wireless link, such as a satellite link, or a wired link, such as a cable connection). Similarly, the communication channel may also be a telephony based connection, such as DSL and the like. Regardless of the type of channel, the digital content and/or the distribution of the digital content is typically secured using a conditional access (CA) mechanism and a digital rights management (DRM) mechanism (e.g., encryption/decryption using keys).

In some cases, content is delivered from a server to a client device using point-to-point communication, such as a video-on-demand (VOD) service. In such systems, content is typically encrypted as it is moved between various servers and devices in order to prevent unauthorized access to the content. For security reasons, it is desirable to minimize sharing of the cryptographic keys used to encrypt the content. In particular, it is desirable to minimize sharing of cryptographic key data with the client devices. Accordingly, there exists a need in the art for a method and apparatus for distributing content to a client device that exhibits minimal key sharing with the client devices.

### SUMMARY OF THE INVENTION

Method, apparatus, and computer readable medium for distributing content to a client device is described. One aspect of the invention relates to distributing pre-encrypted content. In one embodiment, pre-encrypted content is received at a server. Pre-encryption key data associated with the pre-encrypted content is obtained. The pre-encrypted content is decrypted using the pre-encryption key data to produce portions of clear content. The portions of clear content are then re-encrypted as each portion is produced in accordance with unique key data to produce re-encrypted content. The re-encrypted content is distributed from the server towards a client device.

### BRIEF DESCRIPTION OF DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a content distribution system constructed in accordance with one or more aspects of the invention;

FIG. 2 is a flow diagram depicting an exemplary embodiment of a method for distributing content in accordance with one or more aspects of the invention;

FIG. 3 is a flow diagram depicting another exemplary embodiment of a method for distributing content in accordance with one or more aspects of the invention; and

FIG. 4 is a block diagram depicting an exemplary embodiment of a computer suitable for implementing the processes and methods described herein.

To facilitate understanding, identical reference numerals have been used, where possible, to designate identical elements that are common to the figures.

### DETAILED DESCRIPTION OF THE INVENTION

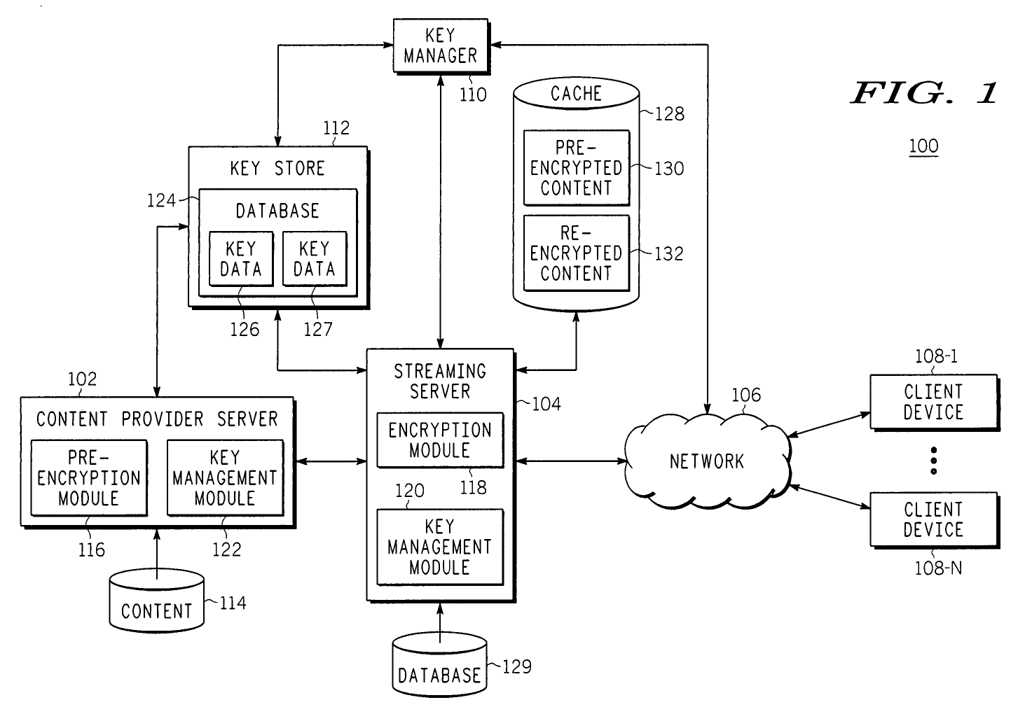

FIG. 1 is a block diagram depicting an exemplary embodiment of a content distribution system 100 constructed in accordance with one or more aspects of the invention. The content distribution system 100 includes a content provider system 102, a streaming server 104, a key manager 110, a key store 1 12, a network 106, and client devices 108-1 through 108-N (collectively referred to as client devices 108), where N is an integer greater than zero. For purposes of clarity by example, only a single streaming server 104 and key manager 110 is shown. Those skilled in the art will appreciate that the content provider system 102 may include one or more streaming servers 104, as well as one or more key managers 110.

The content provider system 102 is configured to provide content to the streaming server 104, which in turn provides the content to the client devices 108 via the network 106. The network 106 may be any type of conventional network known in the art, such as the Internet, a local area network (LAN), a wide area network (WAN), and the like. The client devices 108 may include set top boxes (STBs), media centers, personal video recorder devices, home gateways, computers, cellular telephones, and like type devices for receiving, processing, and/or displaying content.

In particular, the content provider system 102 includes a pre-encryption module 116 and a key management module 122. The content provider system 102 may be in communication with a database 114 having content stored therein. The pre-encryption module 116 is configured to encrypt content using cryptographic key data. The pre-encryption module may use any type of encryption algorithm known in the art, such as the Advanced Encryption Standard (AES). The key management module 122 is configured for communication with the key store 112. The key store 112 includes a database 124 for storing pre-encryption key data 126. The pre-encryption key data 126 may include pairs of a cryptographic key and an identifier associated with the pre-encrypted content.

The key management module 122 establishes a secure session with the key store 112 for publishing or receiving the pre-encryption key data 126. Notably, the key management module 122 may publish the cryptographic key data used to pre-encrypt the content, along with the content identifier, to the key store 112 for storage in the database 124. Alternatively, the key store 112 may generate the cryptographic key data in response to a request from the key management module 122 and distribute the cryptographic key data thereto. The pre-encryption key data 126 may be stored in a secure format within the database 124 (e.g., the pre-encryption key data 126 may be encrypted and the database records may be authenticated).

The content provider system 102 transmits the pre-encrypted content to the streaming server 104. In one embodiment, the content streaming server 104 establishes individual point-to-point streaming sessions with the client devices 108. For example, a video-on-demand (VOD) architecture may be employed, where client devices request video content from the streaming server 104. The point-to-point streaming sessions are secure in that the content delivered to the client devices 108 is encrypted.

In particular, the streaming server 104 includes a re-encryption module 118 and a key management module 120. In one embodiment, the streaming server 104 stores the pre-encrypted content in a cache 128. The cache 128 is configured to store content to be distributed to the client devices 108, in particular, pre-encrypted content 130. In response to a streaming session request from a client device (“session request” ), the key management module 120 requests cryptographic key data for the pre-encrypted content from the key store 112 and returns the data to the streaming server 104.

The re-encryption module 118 decrypts the pre-encrypted content using the pre-encryption key data and re-encrypts the content using unique key data for delivery to the client device via the network 106. The “unique key data” is unique in that it is different from the pre-encryption key data. Notably, the re-encryption process is done on frame-by-frame or packet-by-packet basis such that the entire content is never available in the clear. The streaming server 104 may negotiate with the client device to establish the unique key data used to re-encrypt the pre-encrypted content. Since the pre-encryption key data is never shared with the client devices 108, the pre-encrypted content stored in the cache 128 is secure from unauthorized access by the client devices 108. Moreover, the pre-encryption key data can have a longer duration than the unique key data generated for a given streaming session.

In another embodiment of the invention, upon receiving the pre-encrypted content, the key management module 120 requests pre-encryption key data from the key manager 110. The key manager 110 retrieves the desired pre-encryption key data from the key store 112 and returns the data to the streaming server 104. The re-encryption module 118 decrypts the pre-encrypted content using the pre-encryption key data and re-encrypts the content using unique key data. The re-encrypted content is stored in the cache 128 (re-encrypted content 132). The key management module 120 then establishes a secure session with the key store 112 and publishes the unique key data thereto. Thus, the database 124 stores unique key data 127 for the re-encrypted content 132. Alternatively to, or in addition to storing the unique key data in the key store, the streaming server 104 may store the unique key data locally in a database 129. In response to a session request from a client device, the streaming server 104 delivers the re-encrypted content to the client device via the network 106. The client device may obtain the unique key data used to decrypt the re-encrypted content by issuing a request to the key manager 110. If the unique key data is stored locally in the database 129, the key manager 110 may request access to the database 129 through the streaming server 104. Alternatively, a client device may establish a secure session directly with the streaming server 104 through the key management module 120 to receive the unique key data from the database 129.

In one embodiment, the encrypted content 132 stored in the cache 128 may be periodically decrypted and re-encrypted using different unique key data to minimize key sharing with the client devices 108 to a limited time period. In one embodiment, the re-encryption module 118 decrypts the pre-encrypted content upon receipt and produces a plurality of copies of re-encrypted content, each using different unique key data. During a session, the streaming server 104 randomly selects a copy of the re-encrypted content for delivery to the client device.

In yet another embodiment, the content provider server 102 pre-encrypts the content using over a time period to generate multiple pre-encrypted content streams. Each of the pre-encrypted content streams is associated with pre-encryption key data, where the pre-encryption key data is different than the pre-encryption key data for any other of the pre-encrypted content streams. That is, each of the pre-encrypted content streams has unique pre-encryption key data associated therewith. The pre-encrypted content streams are sent to the streaming server 104 as each pre-encrypted content stream is produced over the time period for storage in the cache 128. The streaming server 104 may replace each pre-encrypted content stream currently stored in the cache 128 with the next received pre-encrypted content stream. Rather than perform the re-encryption process, the streaming server 104 distributes the pre-encrypted content stream currently stored in the cache 128 to the client devices 108. The client devices 108 obtain the pre-encryption key data in a manner similar to that of the unique key data described above (e.g., from the key manager or the streaming server 104). Key sharing is still minimized, since the pre-encryption keys are changing over time. In another embodiment, the content provider server 102 may distribute a plurality of the pre-encrypted content streams at one time, each stream being associated with different pre-encryption key data. During a session, the streaming server 104 randomly selects a stream of the pre-encrypted content streams stored in the cache 128 for delivery to the client device (without performing the re-encryption process).

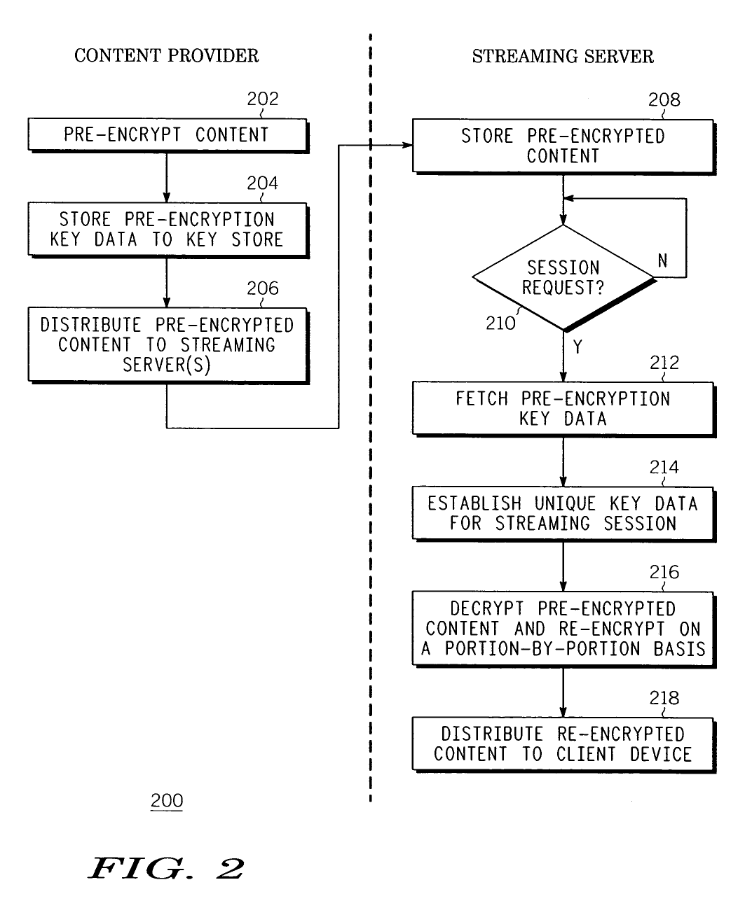

FIG. 2 is a flow diagram depicting an exemplary embodiment of a method 200 for distributing content in accordance with one or more aspects of the invention. The method 200 begins at step 202, where content is pre-encrypted at the content provider. At step 204, pre-encryption key data used to pre-encrypt the content is stored to a key store. At step 206, the pre-encrypted content is distributed to one or more streaming servers. For purposes of clarity, the method 200 is described with respect to operation in a single streaming server. It is to be understood that the multiple streaming servers may be used, each employing similar operation.

At step 208, a streaming server stores the pre-encrypted content. At step 210, a determination is made whether a streaming session has been requested by a client device. If not, step 210 is repeated (i.e., the streaming server waits for a session request). Otherwise, the method 200 proceeds to step 212. At step 212, the pre-encryption key data is fetched from the key store. At step 214, unique key data is established for the streaming session. For example, the streaming server may negotiate unique key data with the client device. At step 216, the pre-encrypted content is decrypted using the pre-encryption key data and re-encrypted using the unique key data on a portion-by-portion basis. For example, the pre-encrypted content may be decrypted and re-encrypted on a frame-by-frame basis or packet-by-packet basis so that the entire content is never in the clear. At step 218, the re-encrypted content is distributed to the client device.

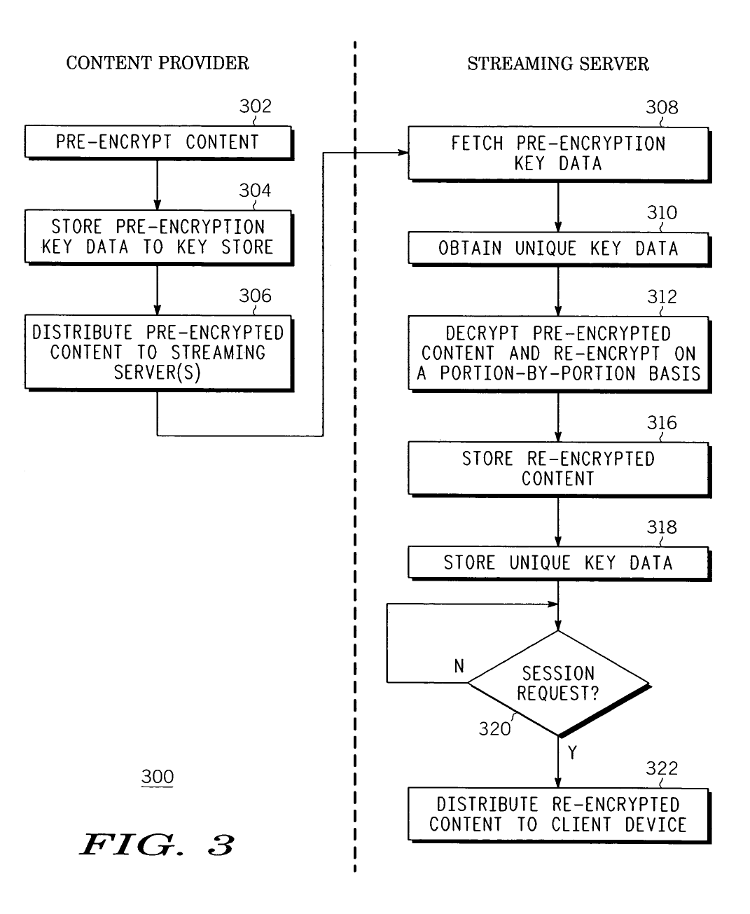

FIG. 3 is a flow diagram depicting another exemplary embodiment of a method 300 for distributing content in accordance with one or more aspects of the invention. The method 300 begins at step 302, where content is pre-encrypted at the content provider. At step 304, pre-encryption key data used to pre-encrypt the content is stored to a key store. At step 306, the pre-encrypted content is distributed to one or more streaming servers. For purposes of clarity, the method 300 is described with respect to operation in a single streaming server. It is to be understood that the multiple streaming servers may be used, each employing similar operation.

At step 308, the pre-encryption key data is fetched from the key store. At step 310, unique key data is obtained. This unique key data may be locally generated or obtained from a key store. At step 312, the pre-encrypted content is decrypted using the pre-encryption key data and re-encrypted using the unique key data on a portion-by portion basis. For example, the pre-encrypted content may be decrypted and re-encrypted on a frame-by-frame or packet-by-packet basis. In one embodiment, the content may be re-encrypted to produce one or more copies of the re-encrypted content, each copy having corresponding unique key data. At step 316, the re-encrypted content is stored. At step 318, the unique key data used to re-encrypt the content is stored. For example, the unique key data may be stored to the key store and/or may be stored locally at the streaming server.

At step 320, a determination is made whether a streaming session has-been requested. If not, step 320 is repeated (i.e., the streaming server waits for a session request). Otherwise, the method 300 proceeds to step 322. At step 322, the re-encrypted content is distributed to the client device. If multiple copies of the re-encrypted content are present, the streaming server may randomly select one copy of the re-encrypted content for distribution to the client device. In addition, the streaming server may periodically re-encrypt the re-encrypted content using different unique key data. For example, the streaming server may re-encrypt any re-encrypted content that has been distributed to a client device using different unique key data.

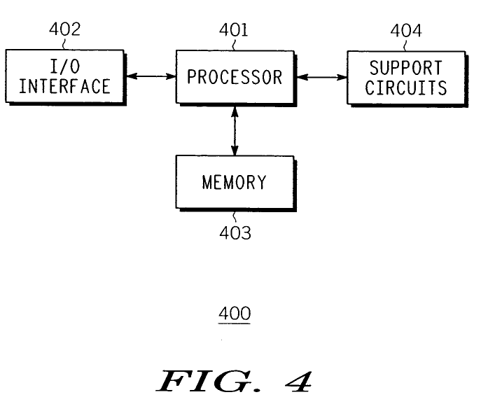

FIG. 4 is a block diagram depicting an exemplary embodiment of a computer 400 suitable for implementing the processes and methods described herein. Notably, the computer 400 may be used to implement the streaming server 104, the content provider server 102, and the processes 300 and 400. The computer 400 includes a processor 401, a memory 403, various support circuits 404, and an I/O interface 402. The processor 401 may be any type of microprocessor known in the art. The support circuits 404 for the processor 401 include conventional cache, power supplies, clock circuits, data registers, I/O interfaces, and the like. The memory 403 may include one or more of the following random access memory, read only memory, magneto-resistive read/write memory, optical read/write memory, cache memory, magnetic read/write memory, and the like, as well as signal-bearing media as described below. The I/O interface 402 may be directly coupled to the memory 403 or coupled through the processor 401.

The memory 403 may store all or portions of one or more programs and/or data to implement the processes and methods described herein. The memory 403 may also be used to store pre-encrypted content and/or re-encrypted content (e.g., hard disc drives). Although one or more aspects of the invention are disclosed as being implemented as a computer executing a software program, those skilled in the art will appreciate that the invention may be implemented in hardware, software, or a combination of hardware and software. Such implementations may include a number of processors independently executing various programs and dedicated hardware, such as ASICs. The computer 400 may be programmed with an operating system, which may be OS/2, Java Virtual Machine, Linux, Solaris, Unix, Windows, Windows95, Windows98, Windows NT, and Windows2000, WindowsME, and WindowsXP, among other known platforms. At least a portion of an operating system may be disposed in the memory 403.

Method and apparatus for distributing content to a client device has been described. In one embodiment, pre-encrypted content is stored at a server in a cache. In response to a request from a client device, the server re-encrypts the pre-encrypted content on a portion-by-portion basis using unique key data and distributes the re-encrypted content to the client device. In this manner, the key data used to pre-encrypt the content is not shared with any client devices. The unique key data that is shared with a client device is changed more often (e.g., changed for every request) thereby minimizing key sharing among client devices. In another embodiment, rather than re-encrypt the pre-encrypted data “on-the-fly” in response to a streaming request, the server may re-encrypt the pre-encrypted data upon the pre-encrypted data being positioned to the server. The re-encrypted content is then stored for later distribution to the client devices. In one embodiment, the server may produce several re-encrypted copies of the pre-encrypted content, each associated with different unique key data. In either case, the stored re-encrypted content may be periodically re-encrypted again using different key data. In yet another embodiment, a content provider server periodically distributes pre-encrypted content streams associated with different pre-encryption key data to the server. Rather than re-encrypting the pre-encrypted content, the server distributes the pre-encrypted content streams to the client devices. In any embodiment, the invention allows for minimal sharing of cryptographic key information with client devices.

An aspect of the invention is implemented as a program product for use with a computer system. Program(s) of the program product defines functions of embodiments and can be contained on a variety of signal-bearing media, which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media (e.g., floppy disks within a diskette drive or hard-disk drive or read/writable CD or read/writable DVD); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

While the foregoing is directed to illustrative embodiments of the present invention, other and further embodiments of the invention may be devised without departing from the basic scope thereof, and the scope thereof is determined by the claims that follow.

What is claimed is:

1. A method of distributing pre-encrypted content, comprising:
storing the pre-encrypted content in a cache at a server;
obtaining pre-encryption key data associated with the pre-encrypted content;
decrypting the pre-encrypted content using the pre-encryption key data to produce portions of clear content;
re-encrypting the portions of clear content as each portion is produced in accordance with unique key data to produce re-encrypted content; and
distributing the re-encrypted content from the server towards a client device.

2. The method of claim 1, further comprising:
receiving a session request at the server;
wherein the steps of obtaining, decrypting, re-encrypting, and distributing are preformed in response to the session request.

3. The method of claim 2, further comprising:
negotiating with the client device to establish the unique key data in response to the session request.

4. The method of claim 1, further comprising:
storing the re-encrypted content in a cache;
storing the unique key data in a key store; and
receiving a session request at the server;
wherein the step of distributing is performed in response to the session request.

5. The method of claim 4, wherein the re-encrypted content comprises a plurality of copies, and the unique key data comprises a plurality of unique keys respectively associated with the plurality of copies.

6. The method of claim 5, wherein the step of distributing comprises:
randomly selecting a copy of the plurality of copies; and
transmitting the copy towards the client device.

7. The method of claim 4, further comprising:
periodically decrypting and re-encrypting the re-encrypted content stored in the cache using different unique key data.

8. Apparatus for distributing pre-encrypted content, comprising:
a cache for storing the pre-encrypted content;
a key management module for obtaining pre-encryption key data associated with the pre-encrypted content;
a re-encryption module for decrypting the pre-encrypted content using the pre-encryption key data to produce portions of clear content and re-encrypting the portions of clear content as each portion is produced in accordance with unique key data to produce re-encrypted content; and
means for distributing the re-encrypted content towards a client device.

9. The apparatus of claim 8, further comprising:
means for receiving a session request;
wherein the key management module is configured to obtain the pre-encryption key data, the re-encryption module is configured to decrypt and re-encrypt, and the re-encrypted content is distributed towards the client device in response to the session request.

10. The apparatus of claim 9, further comprising:
means for negotiating with the client device to establish the unique key data in response to the session request.

11. The apparatus of claim 8, wherein the cache is further configured to store the re-encrypted content, and wherein the apparatus further comprises:
a key store for storing the unique key data; and
means for receiving a session request;
wherein the re-encrypted content is distributed towards the client device in response to the session request.

12. The apparatus of claim 11, wherein the re-encrypted content comprises a plurality of copies, and the unique key data comprises a plurality of unique keys respectively associated with the plurality of copies.

13. The apparatus of claim 12, wherein the means for distributing comprises:
means for randomly selecting a copy of the plurality of copies; and
means for transmitting the copy towards the client device.

14. The apparatus of claim 11, wherein the re-encryption module is configured to periodically decrypt and re-encrypt the re-encrypted content stored in the cache using different unique key data.

15. A computer readable medium having stored thereon instructions that, when executed by a processor, cause the processor to perform a method of distributing pre-encrypted content, comprising:
storing the pre-encrypted content in a cache;
obtaining pre-encryption key data associated with the pre-encrypted content;
decrypting the pre-encrypted content using the pre-encryption key data to produce portions of clear content;
re-encrypting the portions of clear content as each portion is produced in accordance with unique key data to produce re-encrypted content; and
distributing the re-encrypted content towards a client device.

16. The computer readable medium of claim 15, further comprising:
storing the re-encrypted content in a cache;
storing the unique key data in a key store; and
receiving a session request;
wherein the step of distributing is performed in response to the session request.

17. The computer readable medium of claim 16, wherein the re-encrypted content comprises a plurality of copies, and the unique key data comprises a plurality of unique keys respectively associated with the plurality of copies.

18. The computer readable medium of claim 17, wherein the step of distributing comprises:
randomly selecting a copy of the plurality of copies; and
transmitting the copy towards the client device.

19. The computer readable medium of claim 16, further comprising:
periodically decrypting and re-encrypting the re-encrypted content stored in the cache using different unique key data.

20. A method of distributing pre-encrypted content, comprising:
pre-encrypting content at a content provider server over a time period to generate pre-encrypted content streams, each of the pre-encrypted content streams being associated with pre-encryption key data, the pre-encryption key data being different than the pre-encryption key data for any other of the pre-encrypted content streams;
sending each of the pre-encrypted content streams to a streaming server as each pre-encrypted content stream is produced over the time period; and
distributing, over the time period, at least one of the pre-encrypted content streams towards at least one client device.
